(19) United States
(12) Patent Application Publication
(10) Pub. No.: US 2013/0080991 A1
(43) Pub. Date: Mar. 28, 2013

(54) PATTERN FORMING APPARATUS

(71) Applicants: Ryoichi Inanami, Yokohama-shi (JP); Akiko Mimotogi, Yokohama-shi (JP); Hiroyuki Kashiwagi, Fujisawa-shi (JP)

(72) Inventors: Ryoichi Inanami, Yokohama-shi (JP); Akiko Mimotogi, Yokohama-shi (JP); Hiroyuki Kashiwagi, Fujisawa-shi (JP)

(21) Appl. No.: 13/428,276

(22) Filed: Mar. 23, 2012

(30) Foreign Application Priority Data
Sep. 22, 2011 (JP) 2011-207687

(51) Int. Cl. G06F 11/22

(52) U.S. Cl. 716/136

(57) ABSTRACT

According to one embodiment, a pattern forming apparatus includes a control unit. The control unit is configured to execute a test patterning to same patterns using probes under same conditions, obtain a position error and a size error by comparing a position and a size of the same patterns with a target value, select a normal probe in which the position error and the size error is in an allowable range among the probes, execute a correction process which adjusts sub patterning areas which are patterned by the normal probe among a main patterning area of a substrate, and execute a patterning of the sub patterning areas using the normal probe.

### CROSS-REFERENCE TO RELATED APPLICATIONS

This application is based upon and claims the benefit of priority from prior Japanese Patent Application No. 2011-207687, filed Sep. 22, 2011, the entire contents of which are incorporated herein by reference.

### FIELD

Embodiments described herein relate generally to a pattern forming apparatus.

### BACKGROUND

There are known probe lithography technologies which form a micropattern of a nanometer level using a microprobe used in an atomic force microscope, a tunnel current microscope, and the like. For example, an anode oxidation method, an electron beam lithography, and further a method of forming a pattern by dropping a small amount of solution from a tip of a probe, a method of depositing a material adsorbed to a tip of a probe on a substrate, and the like are one of the probe lithography technologies.

When a micropattern is formed using the technology, a problem arises in that a lithography time necessary to lithograph all of micropatterns becomes very long. When, for example, an entire surface of a 300-mm wafer which is used to manufacture a semiconductor device is scanned by one probe, an unrealistic time of about seven hundred and ninety thousand days is required even at a scan speed of 10 μm/s and a scan pitch of 100 nm. Further, even if it is assumed that an area in which a micropattern is formed is about 25% of an area of the 300-mm wafer, a lithography time exceeding ten thousand days is necessary.

Thus, a multiprobe lithography technology which lithographs a micropattern by driving probes at the same time is examined. When it is assumed, for example, that a number of probes used to a lithography are ten-thousandth probes, since one wafer can be processed in about one day (24 hours), it is not a dream to put the probe lithography technology into practical use. However, when the lithography is executed by probes, characteristics (a position error, a shape/size dispersion of tips, and the like) of the probes must be naturally examined.

### BRIEF DESCRIPTION OF THE DRAWINGS

FIG. 1 is a view showing a pattern forming apparatus;

FIG. 2 is a view showing a normal probe and an abnormal probe;

FIG. 3 is a view showing a normal pattern and an abnormal pattern;

FIG. 4 is a flowchart showing a first example of a pattern forming process;

FIG. 5 is a flowchart showing a second example of the pattern forming process;

FIG. 6 is a view showing a. probe unit;

FIG. 7 is a view showing a main lithography area and sub lithography areas;

FIG. 8 is a flowchart showing a first example of a correction process;

FIG. 9 is a view showing a correspondence relation between probes and sub lithography areas;

FIG. 10 is a flowchart showing a second example of the correction process;

FIG. 11 is a view showing a correspondence relation between probes and sub lithography areas; and

FIG. 12 is a view showing a multiple lithography of sub lithography areas.

### DETAILED DESCRIPTION

In general, according to one embodiment, a pattern forming apparatus comprising: a stage provided under a lower surface of a substrate; probes provided above an upper surface of the substrate; a drive unit which drives at least one of the stage and the probes; a patterning unit connected to the probes; and a control unit which controls the drive unit and the patterning unit, wherein the control unit is configured to execute a test patterning to same patterns using the probes under same conditions, obtain a position error and a size error by comparing a position and a size of the same patterns with a target value, select a normal probe in which the position error and the size error is in an allowable range among the probes, execute a correction process which adjusts sub patterning areas which are patterned by the normal probe among a main patterning area of the substrate, and execute a patterning of the sub patterning areas using the normal probe.

An embodiment will be explained below referring to the drawings.

A multi probe lithography (patterning) technology is a technology which forms a pattern using probes. A problem of the technology resides in that characteristics of probes are changed by a manufacture error, a variation per hour, and the like. For example, probes do not lithograph same patterns under same conditions at all times and as a result, histories of use of the probes are inevitably different. Accordingly, a probe having a high use frequency is worn and deformed faster than other probe and may be broken and become an abnormal probe which cannot be used in some instances.

Thus, in the following embodiment, in view of the circumstances, the characteristics of the probes (a position error, a size error, and the like of a lithographed pattern) are detected at real time, normal probes the characteristics of which are in an allowable range are selected and a lithography (a pattering) is executed using only the normal probes. That is, abnormal probes the characteristics of which are outside of the allowable range are not used to the lithography.

Further, when a predetermined period passes, for example, when a number of times of lithography run to a predetermined value, the characteristics of the probes are detected again. As described above, a pattern lithography accuracy can be improved by periodically detecting the abnormal probes.

Further, after a correction process which adjusts sub lithography areas (sub patterning areas), to which the normal probes execute the lithography, in a main lithography area (a main patterning area) of a substrate is executed, the sub lithography areas are lithographed using only the normal probes. As described above, the pattern lithography accuracy can be more improved by adjusting lithography areas assigned by the normal probes.

1. Embodiment

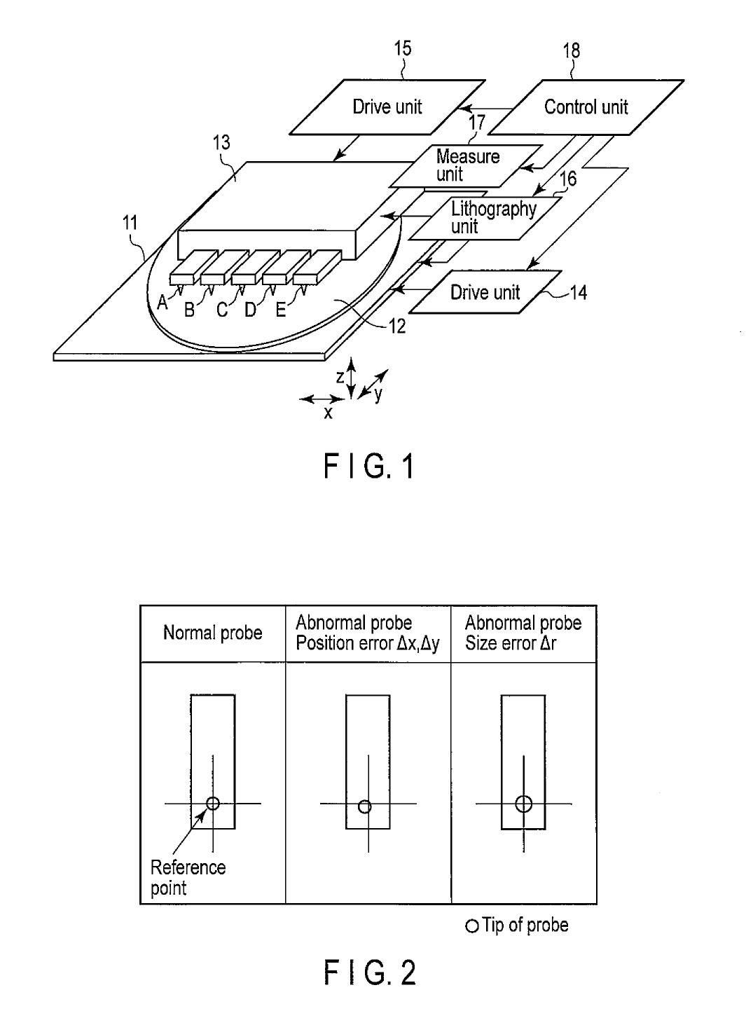

FIG. 1 shows an embodiment of a pattern forming apparatus.

Stage 11 is provided under a lower surface of substrate (substrate to be processed) 12. Stage 11 has a function which supports substrate 12 and applies a fixed potential (for example, positive potential) to the lower surface of substrate 12. Substrate 12 is, for example, a semiconductor wafer.

Probe unit 13 is provided above an upper surface of substrate 12. Probe unit 13 has probes A, B, C, D, E. Although each of probes A, B, C, D, E has, for example, a cantilever type, it is not limited thereto. A lithography to substrate 12 can be executed by, for example, controlling each potential of probes A, B, C, D, E and controlling electrons discharged from the respective probes.

In the example, although a number of probes A, B, C, D, E of probe unit 13 are five, they are not limited thereto. Further, a. number of probe unit 13 provided above the upper surface of substrate 12 is not limited to one. For example, the number of probe units 13 may be set to two or more

Drive units 14, 15 drive at least one of stage 11 and probe 13. When only stage 11 is driven, drive unit 15 may be omitted. Further, when only probe unit 13 is driven, drive unit 14 may be omitted. Naturally, both stage 11 and probe unit 13 may be driven using drive units 14, 15.

Drive unit 14 drives stage 11. For example, drive unit 14 drives stage 11 two-dimensionally (in an x-y direction). However, it is also possible to drive stage 11 by drive unit 14 one-dimensionally or three-dimensionally.

Drive unit 15 drives probe unit 13. For example, drive unit 15 drives probe unit 13 one-dimensionally (in a z-direction). However, it is also possible to drive probe unit 13 by drive unit 15 two-dimensionally or three-dimensionally.

Lithography unit 16 is electrically connected to each of probes A, B, C, D, F via probe unit 13 to execute the lithography to a main lithography area in substrate 12.

Measure unit 18 is provided to measure a position and a size of test-lithographed patterns to execute a correction process of characteristics of probes A, B, C, D, E. A test lithography is executed by lithographing same patterns under same conditions using probes A, B, C, D, E.

Measure unit 18 determines an error of a position and a size of test-lithographed patterns to a target value as a position error and a size error.

Control unit 17 controls drive units 14, 15 and lithography unit 16. Control unit 17 changes a relative position between substrate 12 and probe unit 13. For example, control unit 17 controls drive units 14, 15 so that probes A, B, C, D, F in probe unit 13 execute a scan linearly to substrate 12.

Further, control unit 17 selects normal probes whose position error and size error determined by measure unit 18 is in an allowable range among probes A, B, C, D, E, executes the correction process which adjusts sub lithography areas which are lithographed by the normal probes in the main lithography area of substrate 12, and executes the lithography of the sub lithography areas using the normal probes.

FIG. 2 shows a normal probe and an abnormal probe.

In the normal probe, a center point of the probe agrees with a reference point thereof.

On the contrary, when a position error Δx, Δy is not in an allowable range, a probe having the position error Δx, Δy is treated as the abnormal probe which cannot be used. Further, a probe having a size error Δr is treated as the abnormal probe which cannot be used when the size error Δr is not in an allowable range.

As described above, the abnormal probe is generated by the position error, the size error and a combination thereof.

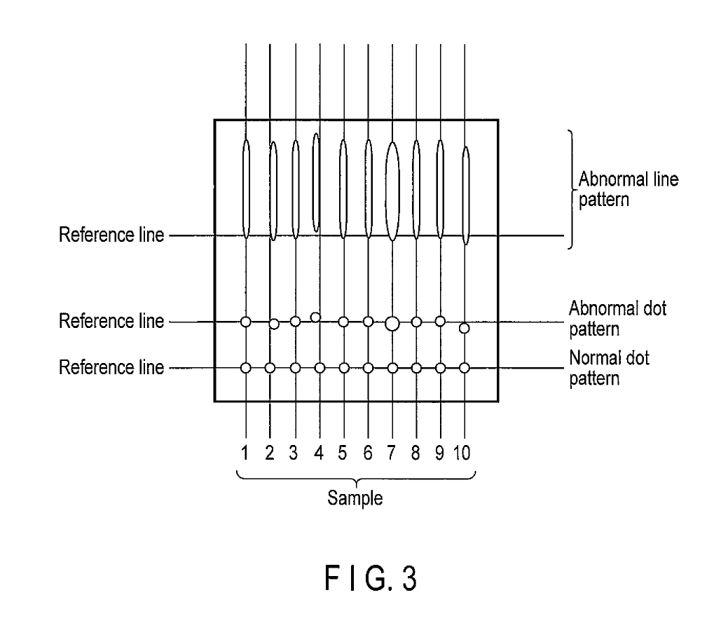

FIG. 3 shows a normal pattern and an abnormal pattern.

Samples 1 to 10 correspond to the respective probes.

When each of the samples 1 to 10 is the normal probe, a normal dot pattern is a dot pattern which is lithographed by each of the samples.

On the contrary, when each of the samples 1 to 10 is the abnormal probe having the position error or the size error, an abnormal dot pattern is a dot pattern lithographed each of the samples. Further, when each of the samples 1 to 10 is the abnormal probe, an abnormal line pattern is a line pattern lithographed each of the samples.

As described above, when a pattern lithographed using the abnormal probe, even if same patterns are lithographed under same conditions, a dispersion occurs in each pattern.

Thus, in the embodiment, the correction process which uses only the normal probe is added in a pattern forming process.

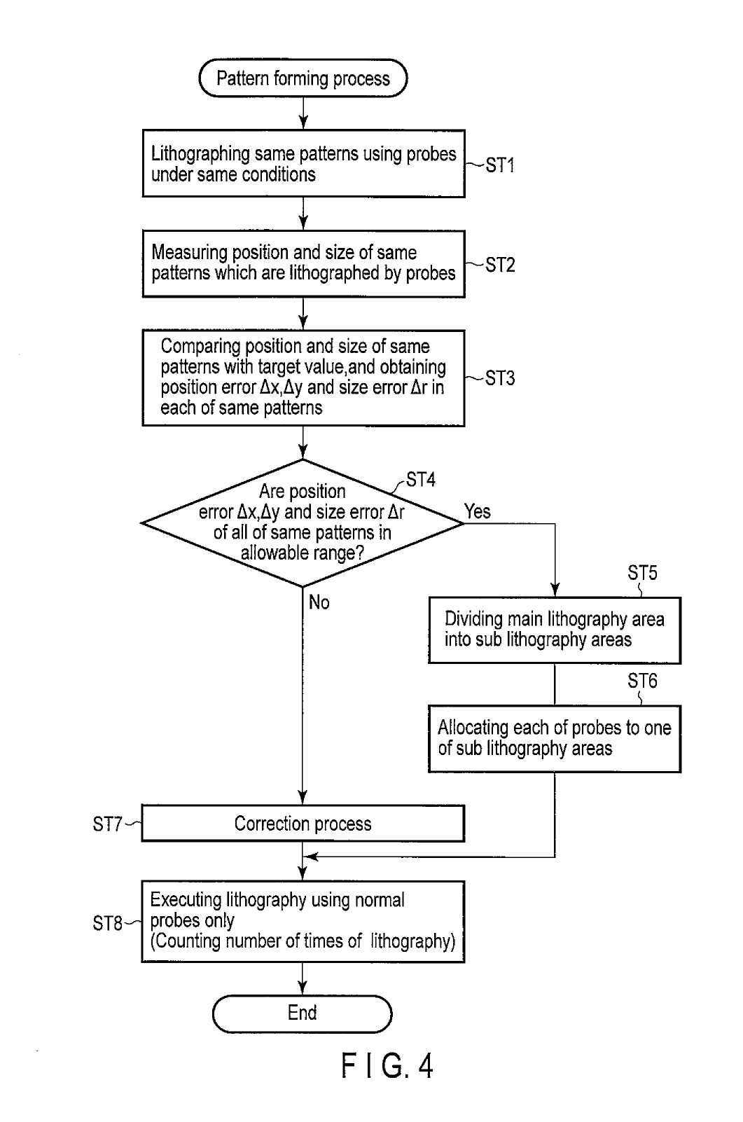

FIG. 4 shows a first example of the pattern forming process.

The pattern, forming process is executed using the pattern forming apparatus of FIG. 1.

First, a test lithography which lithographs same patterns using the probes in the probe unit under same conditions is executed (step ST1). For example, the test lithography is executed by lithographing dot patterns and line patterns under same conditions.

Next, a position and a size of the lithographed patterns are measured by the measure unit (step ST2).

For example, as shown in FIG. 3, when all of the probes are normal, the lithographed patterns, for example, the dot patterns are provided side by side in same sizes at a predetermined pitch. However, patterns, for example, dot patterns and line patterns lithographed by probes having a position error or a size error due to a cause of, for example, a manufacturing dispersion and the like have a dispersion of a position, a size, and the like.

Thus, the position and the size of the patterns are compared with a target value, and the position error Δx, Δy and the size error Δr of each pattern are obtained (step ST3).

Thereafter, whether or not the position error Δx, Δy and the size error Δr of all of the patterns are in the allowable range is determined (step ST4).

When the position error Δx, Δy and the size error Δr of all of the patterns are in the allowable range, it is determined that all of the probes in the probe unit are the normal probes.

In the case, a main lithography area is divided into sub lithography areas (step ST5), and each of the probes (normal probes) is allocated to one of the sub lithography areas (step ST6).

Then, the lithography is executed using only the normal probes. Further, before or after the lithography is executed, a number of times of lithography are counted (step ST8).

Further, when the position error Δx, Δy or the size error Δr of at least one pattern is not in the allowable range, the correction process which allows only the normal probes to be used to the lithography is executed (step ST7).

Specific examples of the correction process will be described later.

Note that the pattern forming process may be executed each time the lithography (pattern formation) is executed or may be executed after a predetermined period or a predetermined. number of times of lithography pass. In the former case, a count of the number of times of lithography at step ST8 may be omitted.

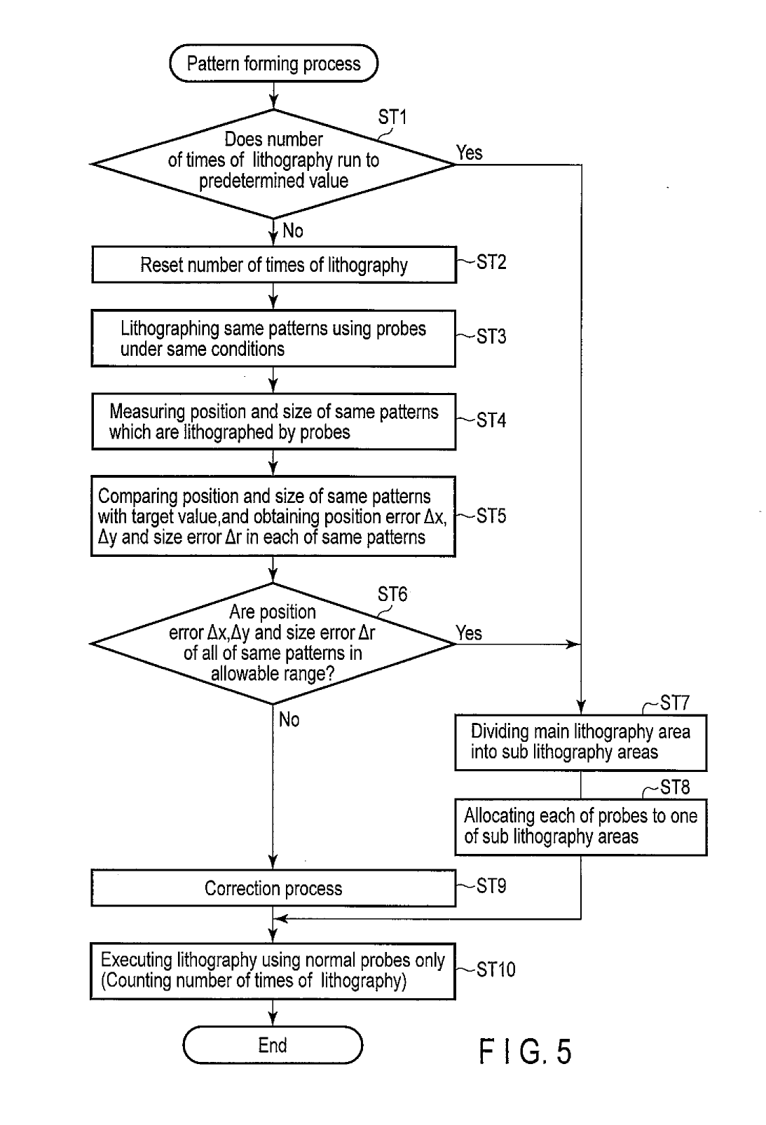

FIG. 5 shows second example of the pattern forming process.

The pattern forming process is executed using also the pattern forming apparatus of FIG. 1.

The second example is different from the first example in that, in the pattern forming process, whether or not the correction process is executed is determined periodically, that is, after a predetermined period or a predetermined number of times of lithography pass. Here, an example that whether or not the correction process is executed periodically is determined using the number of times of lithography as a reference will be explained.

First, whether or not the number of times of lithography runs to a predetermined value is determined (step ST1).

When the number of times of lithography does not run to the predetermined value, a main lithography area is divided into sub lithography areas (step ST7), and each of the probes (normal probes) is allocated to one of the sub lithography areas (step ST8).

Then, the lithography is executed using only the normal probes. Further, before or after the lithography is executed, the number of times of lithography is counted (step ST10).

Further, when the number of times of lithography runs to the predetermined value, the number of times of lithography (count value) is reset (step ST2).

Then, a test lithography which lithographs same patterns using the probes in the probe unit under same conditions is executed (step ST3). For example, the test lithograph is executed by lithographing dot patterns and line patterns under the same conditions.

Next, a position and a size of the lithographed patterns are measure by the measure unit (step ST4).

For example, as shown in FIG. 3, when all of the probes are normal, the lithographed patterns, for example, the dot patterns are provided side by side in same sizes at a predetermined pitch. However, patterns, for example, dot patterns and line patterns lithographed by probes to which a position error or a size error is generated due to a use history and the like have a dispersion in a position, a size, and the like.

Thus, the position and the size of the patterns are compared with a target value, and the position error Δx, Δy and the size error Δr of the each pattern are obtained (step ST5).

Thereafter, whether or not the position error Δx, Δy and the size error Δr of all of the patterns are in the allowable range is determined (step ST6).

When the position error Δx, Δy and the size error Δr of all of the patterns are in the allowable range, it is determined that all of the probes in the probe unit are the normal probes.

In the case, a main lithography area is divided into sub lithography areas (step ST7), and each of the probes (normal probes) is allocated to one of the sub lithography areas (step ST8).

Then, the lithography is executed using only the normal probes. Further, before or after the lithography is executed, a number of times of lithography are counted (step ST10).

Further, when the position error, Δx, Δy or the size error Δr of at least one pattern is not in the allowable range, the correction process which allows only the normal probes to be used to the lithography is executed (step ST9).

The specific examples of the correction process will be described later.

As described above, according to the first and second examples, since the correction process which allows the lithography to be executed using only the normal probes among the probes in the probe unit, is executed, an improvement of a pattern lithography accuracy can be realized. Further, a reduction of TAT (turn around time), a reduction of manufacturing cost, and the like can be achieved.

Next, the specific examples of the correction process will be explained.

First, a premise condition will be explained.

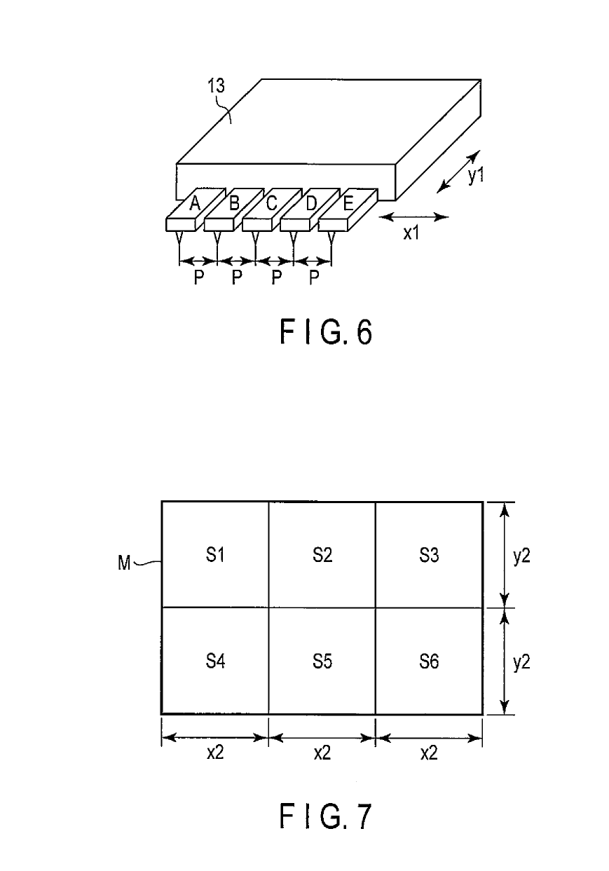

As shown in FIG. 6, it is assumed that probe unit 13 has the probes A, B, C, D, B which are provided in an x-direction at the predetermined pitch p. Further, a movable range of probe unit 13 is set to x1 in the x-direction and to y1 in a y-direction.

Further, as shown in FIG. 7, it is assumed that a size of main lithography area M in the substrate is (x2×3)×(y2×2). Main lithography area M is divided into six sub lithography areas S1, S2, S3, S4, S5, S6. It is assumed that a size of each sub lithography area is x2×y2.

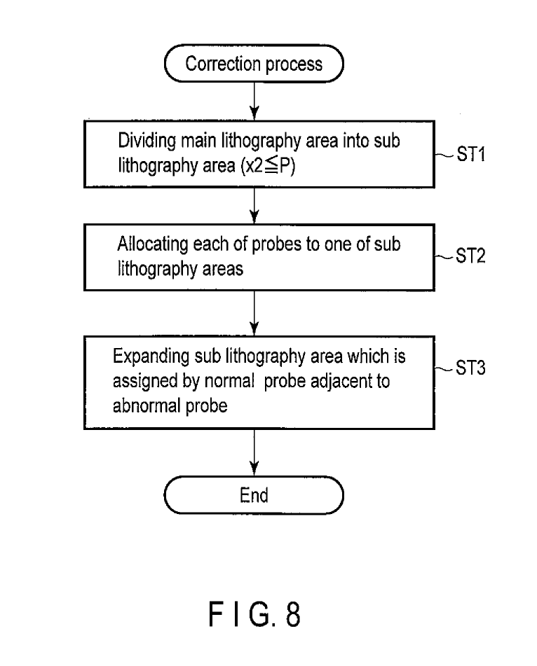

FIG. 8 shows a first example of the correction process.

First, a main lithography area on a substrate is divided into sub lithography areas (step ST1). Here, a size x2 of each sub lithography area in the x-direction is equal to or less than a pitch p of probes in the x-direction (x2≦p).

For example, x1=y1=100 μm, x2=p=30 μm.

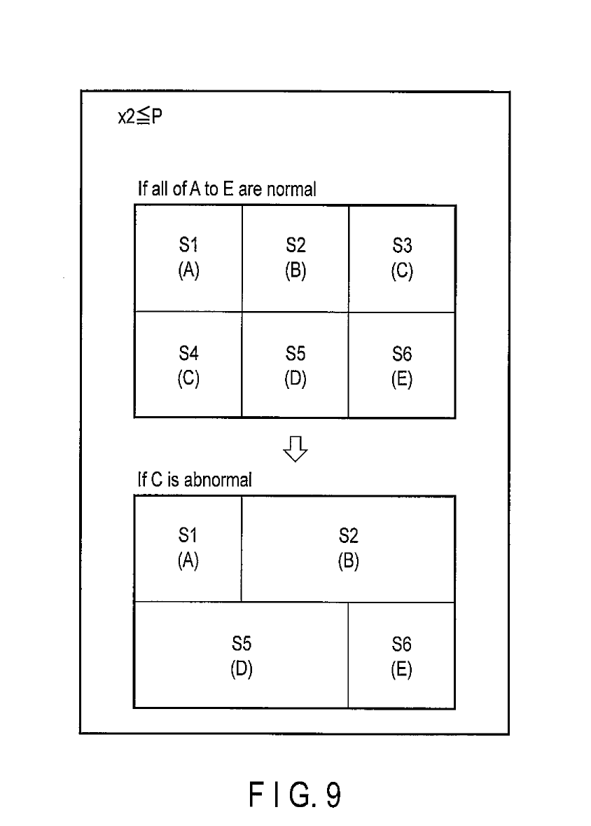

Next, each of the probes is allocated to one of the sub lithography areas (step ST2). For example, as shown in FIG. 9 (when it is assumed that all of A to E are normal), sub lithography areas S1, S2, S3 are caused to correspond to probes A, B, C. Further, the sub lithography areas S4, S5, S6 are caused to correspond to the probes C, D, E.

Thereafter, the allocation at step ST2 is changed. That is, a sub lithography area assigned by a normal probe adjacent to an abnormal probe is expanded (step ST3).

For example, as shown in FIG. 9 (when C is abnormal), when probe C is abnormal, sub lithography area S2 assigned by normal probe B adjacent to abnormal probe C is expanded, and sub lithography area S5 assigned by probe D adjacent to abnormal probe C is expanded.

Then, the sub lithography areas in the main lithography area are lithographed using only the normal probes among the probes.

According to the correction process described above, even if an abnormal probe is generated, a highly accurate lithography can be executed only by expanding a range lithographed by a normal probe adjacent to the abnormal probe.

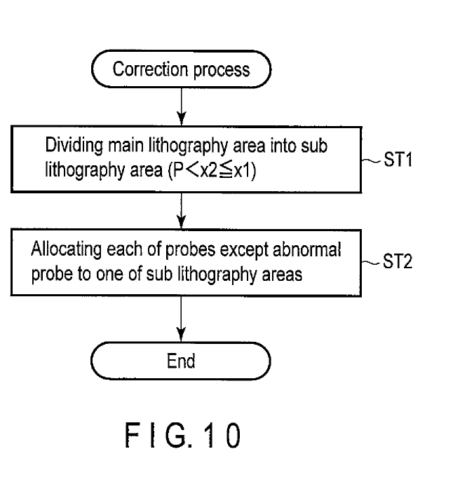

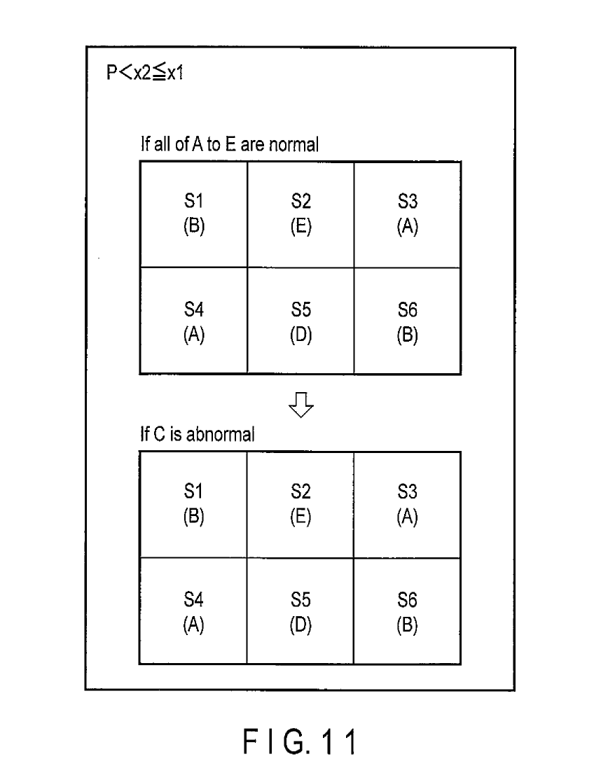

FIG. 10 shows a second example of the correction process.

First, a main lithography area on a substrate is divided into sub lithography areas (step ST1). Here, a size x2 of each sub lithography area in the x-direction is larger than a pitch p of probes in the x-direction and equal to or less than a movable range x1 of a probe unit in the x-direction (p<x2≦x1).

For example, x2=100 μm, p=30 μm. To reduce a lithography time as much as possible, it is desirable to make x1 near or equal to x2.

Next, each of the probes (except an abnormal probe) is allocated to one of the sub lithography areas (step ST2).

Here, in the example, a predetermined correspondence relation can be kept between the probes and the sub lithography areas regardless of presence or absence of the abnormal probe.

For example, as shown in FIG. 11 (when all of A to E are normal), sub lithography areas S1, S2, S3 are caused to correspond to probes B, F, A. Further, sub lithography areas S4, S5, S6 are caused to correspond to probes A, D, B.

Further, for example, as shown in FIG. 11 (when C is abnormal), when probe C is abnormal, sub lithography areas S1, S2, S3 are caused to correspond to the probes B, E, A. Further, sub lithography areas S4, S5, S6 are caused to correspond to probes A, B, B.

As described above, a predetermined correspondence relation can be kept between the probes and the sub lithography areas regardless of presence hr absence of the abnormal probe.

This is because, in the lithography (scan) executed at a time, the lithography is executed using only some of probes A, B, C, D, E at the same time without using all of the probes.

For example, in the example, two sub lithography areas S1, S2 are lithographed at the same time using one (probe B) of three adjacent probes A, B, C and one (probe B) of three adjacent probes C, D, E. Further, two sub lithography areas S4, S5 are lithographed at the same time using one (probe A) of three adjacent probes A, B, C and one (probe D) of three adjacent probes C, D, E.

In the case, the lithography can be executed without changing the correspondence relation between the probes A, B, C, D, E and the sub lithography areas S1, S2, S3, S4, S5, S6 regardless that the probe C is normal or abnormal.

According to the correction process, even if an abnormal probe is generated, since the correspondence relation between the probes and the sub lithography areas can be kept, the highly accurate lithography can be continuously executed by a simple control

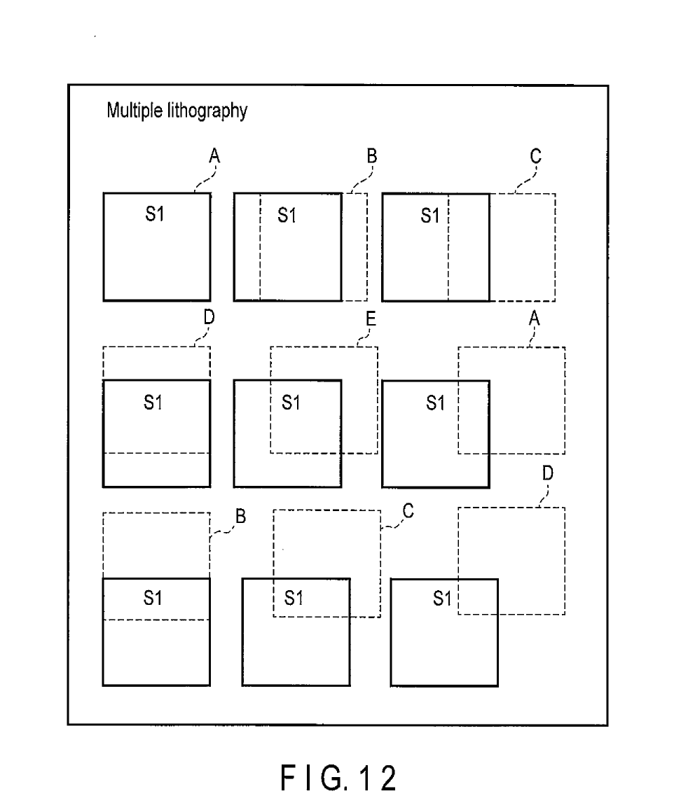

FIG. 12 shows a lithography method.

The lithography method relates to a so-called multiple lithography technology which lithographs one sub lithography area using probes plural times.

According to the lithography method, the lithography accuracy can be more improved by combining the lithography method with the pattern forming process (including the correction process) described above.

In the example, an example will be explained in which sub lithography area Si of FIG. 7 is lithographed by executing the lithography using five probes A, B, C, D, E nine times.

Ranges of a pattern lithographed in the sub lithography area Si by the lithography (scan) executed at a time by the respective probes are different. When, for example, a lithography range at a first time is used as a reference, a lithography range at a second time is shifted by a predetermined value in the x-direction or the y-direction with respect to the lithography range of the first time. Lithography ranges at a third time and subsequent times are shifted by the predetermined value in the x-direction or the y-direction with respect to the lithography ranges in all of the lithographies executed before the third time.

In the example, first, the lithography at a first time is executed using probe A. Further, the lithography at a second time is executed using probe B, the lithography at a third time is executed using probe C, the lithography at a fourth time is executed using probe D, and a lithography at a fifth time is executed using probe E. Further, the lithography at a sixth time is executed using probe A, the lithography at a seventh time is executed using probe B, the lithography at an eighth time is executed using probe C, and the lithography at a ninth time is executed using probe D.

In the drawing, overlap areas of sub lithography areas Si with movable ranges (broken lines) of the respective probes are actual lithography areas.

Note that lithographies by three probes A, B, C at first to third times can be also executed simultaneously. Likewise, lithographies by three probes D, E, A at fourth to sixth times can be executed also at the same time, and lithographies by three probes B, C, D at seventh to ninth times can be executed also at the same time.

As described above, when the multiple lithography technology is used, the pattern lithography accuracy can be improved by lithographing a pattern in one sub lithography area by overlapping lithographies executed nine times. Further, even if an abnormal probe is generated, a reduction of pattern lithography accuracy caused by the abnormal probe can be reduced to one-ninth a case that the lithography is executed by one probe.

Note that, according to the multiple lithography technology, since a time necessary to the lithography executed at a time can be reduced, even if the lithography is executed to one sub lithography area plural times, a lithography time does not extremely increase. That is, even if the multiple lithography technology is employed, a reduction of TAT, a reduction of manufacturing cost, and the like can be achieved.

2 Others

The pattern forming apparatus of FIG. 1 can be manufactured by applying SPM (scanning probe microscope) such as an atomic force microscope, a tunnel current microscope, and the like. Further, as to a multi probe, to form an enormous number of probes such as ten thousand probes, it is preferable to form probes, in, for example, a wafer making use of HEMS (microelectronic mechanical system) technology.

Further, since the pattern forming process (including the correction process) described above can be continuously executed in the pattern forming apparatus of FIG. 1, a job which carries in and out a substrate is not necessary, which can contribute to improve a manufacture yield.

Further, as to a formation of pattern, a size of a pattern to be lithographed can be controlled by adjusting a scan speed of a probe, a distance between the probe and a substrate, and the like. Further, the size of the pattern to be lithographed can be controlled also by physical amounts and the like such as a current value/a voltage value between a probe and a substrate, a pressure force of the probe applied to the substrate, and a temperature, a humidity, and the like in the pattern forming apparatus.

3. Conclusion

According to the embodiment, a pattern lithography accuracy in a multi probe lithography technology can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pattern forming apparatus comprising:
a stage provided under a lower surface of a substrate;
probes provided above an upper surface of the substrate;
a drive unit which drives at least one of the stage and the probes;
a patterning unit connected to the probes; and
a control unit which controls the drive unit and the patterning unit,
wherein the control unit is configured to execute a test patterning to same patterns using the probes under same conditions, obtain a position error and a size error by comparing a position and a size of the same patterns with a target value, select a normal probes in which the position error and the size error is in an allowable range among the probes, execute a correction, process which adjusts sub patterning areas which are patterned by the normal probes among a main patterning area of the substrate, and execute a patterning of the sub patterning areas using the normal probes.

2. The apparatus of claim 1,
wherein the control unit is configured to re-execute the test patterning and the correction process, when a number of times of the patterning by the normal probes run to a predetermined value.

3. The apparatus of claim 1,
further comprising a measure unit which measures the position and the size of the same patterns,
wherein the position error and the size error are obtained by the measure unit.

4. The apparatus of claim 1,
wherein the control unit is configured to divide the main patterning area into the sub patterning areas which has a width of x2 in a pitch direction when a pitch in the pitch direction of the probes is p, and allocate each of the probes to one of the sub patterning areas, where x2 p.

5. The apparatus of claim 4,
wherein the control unit is configured to cancel the sub patterning area allocated to the abnormal probe when one of the probes is the abnormal probe, and expand the width in the pitch direction of the sub patterning area allocated to the normal probe adjacent to the abnormal probe.

6. The apparatus of claim 1,
wherein the control unit is configured to divide the main patterning area into the sub patterning areas which has a width of x2 in a pitch direction when a pitch in the pitch direction of the probes is p, and allocate each of the probes to one of the sub patterning areas, where p<x2.

7. The apparatus of claim 6,
wherein p<x2≦x1, where x1 is a movable range of the probes in the pitch direction.

8. The apparatus of claim 7,
wherein the control unit is configured to allocate each of the probes except the abnormal probe to one of the sub patterning areas as the normal probe when one of the probes is the abnormal probe.

9. The apparatus of claim 1,
wherein the control unit is configured to divide the main patterning area into the sub patterning areas, and execute a patterning of each of the sub patterning areas with at least two probes among the probes.

10. The apparatus of claim 1,
wherein the sub patterning areas is arranged in matrix.

11. A method of forming a pattern by using a pattern forming apparatus,
the apparatus comprising:
a stage provided under a lower surface of a substrate;
probes provided above an upper surface of the substrate;
a drive unit which drives at least one of the stage and the probes;
a patterning unit connected to the probes; and
a control unit which controls the drive unit and the patterning unit,
the method comprising:
executing a test patterning to same patterns using the probes under same conditions;
obtaining a position error and a size error by comparing a position and a size of the same patterns with a target value;
selecting normal probes in which the position error and the size error is in an allowable range among the probes;
executing a correction process which adjusts sub patterning areas which are patterned by the normal probes among a main patterning area of the substrate; and
executing a patterning of the sub patterning areas using the normal probes.

12. The method of claim 11,
further comprising re-executing the test patterning and the correction process, when a number of times of the patterning by the normal probe run to a predetermined value.

13. The method of claim 11,
further comprising measuring the position and the size of the same patterns by using a measure unit,
wherein the position error and the size error are obtained by the measure unit.

14. The method of claim 11,
further comprising dividing the main patterning area into the sub patterning areas which has a. width of x2 in a pitch. direction when a pitch in the pitch direction of the probes is p, and allocating each of the probes to one of the sub patterning areas, where x2≦p.

15. The method of claim 14,
further comprising canceling the sub patterning area allocated to the abnormal probe when one of the probes is the abnormal probe, and expanding the width in the pitch direction of the sub patterning area allocated to the normal probe adjacent to the abnormal probe.

16. The method of claim 11,
further comprising dividing the main patterning area into the sub patterning areas which has a width of x2 in a pitch direction when a pitch in the pitch direction of the probes is p, and allocating each of the probes to one of the sub patterning areas, where p<x2.

17. The method of claim 16,
wherein p<x2≦x1, where xl is a movable range of the probes in the pitch direction.

18. The method of claim 17,
further comprising allocating each of the probes except the abnormal probe to one of the sub patterning areas as the normal probe when one of the probes is the abnormal probe.

19. The method of claim 11,
further comprising dividing the main patterning area into the sub patterning areas, and executing a patterning of each of the sub patterning areas by a multiple patterning using at least two probes among the probes.

20. The method of claim 11,
wherein the sub patterning areas is arranged in matrix.

21. A method of forming a pattern, the method comprising:
executing a test patterning to same patterns using probes under same conditions;
obtaining a position error and a size error by comparing a position and a size of the same patterns with a target value;
selecting a normal probe in which the position error and the size error is in an allowable range among the probes;
executing a correction process which adjusts sub patterning areas which are patterned by the normal probe among a main patterning area of a substrate; and
executing a patterning of the sub patterning areas using the normal probe.
